(19) United States
(12) Patent Application Publication
(10) Pub. No.: US 2014/0071856 A1
(43) Pub. Date: Mar. 13, 2014

(54) TIMING ADVANCE INFORMATION FOR ADAPTING NEIGHBOR RELATIONS

(71) Applicants: Arthur Richard Brisebois, Cumming, GA (US); Thomas W. Henderson, Alpharetta, GA (US); Fereidoun Tafreshi, Bellevue, WA (US)

(72) Inventors: Arthur Richard Brisebois, Cumming, GA (US); Thomas W. Henderson, Alpharetta, GA (US); Fereidoun Tafreshi, Bellevue, WA (US)

(73) Assignee: AT&T MOBILITY II LLC, Atlanta, GA (US)

(21) Appl. No.: 13/609,051

(22) Filed: Sep. 10, 2012

(51) Int. Cl. H04W 72/04; H04W 72/10; H04W 36/08; H04W 84/18

(52) U.S. Cl. 370/255; 370/336; 370/331

(57) ABSTRACT

Adjusting radio area network performance by adapting cell coverage area can help optimize the operating efficiency of a wireless network. Base station coverage areas can be determined by analysis of reported timing advance information. This can facilitate adjusting coverage areas. Further, integration with network topology planning components and management components can be employed. Moreover, prioritization of base stations in Automatic Neighbor Relations (ANR) neighbor lists can improve coverage balance by influencing complex heterogeneous coverage layout systems. Historical timing advance information can be employed to facilitate analysis of statistical coverage conditions for cells, analysis of coverage areas as they relate to performance metrics, analysis of coverage areas with regard to specific event such as handovers, etc. Moreover, coverage area analysis can be linked to alarm systems.

### TECHNICAL FIELD

The disclosed subject matter relates to radio area network coverage and, more particularly, to adaptive radio area network coverage.

### BACKGROUND

By way of brief background, coverage area conditions for a radio area network (RAN) can be predicated on the features of the deployed RAN equipment, including base stations, e.g., NodeB or enhanced NodeB (eNodeB). Adaptation of the RAN coverage area, such as correcting for a base station overshoot, determining neighbor rankings for NodeB/eNodeB, optimization of NodeB/eNodeB neighbor lists, etc., has generally not been automated. Where a RAN is comprised of a number of cells, each associated with a base station, e.g., a NodeB/eNodeB, mobile devices can traverse the RAN by sequentially establishing communications links with the base stations. Generally, the mobile device preferentially establishes relations with base stations that are physically closer to the mobile devices. Typically, the closer a base station is to a mobile device the higher quality the communications link will be, all else being equivalent, because the communications signals between the base station and the mobile device have a shorter distance to traverse. As such, it can often be desirable that base stations be distributed across the RAN in a manner that attempts to balance the area of coverage of each cell in the RAN. Where the cells of the RAN are closer in area of coverage, the distances between the edge of a cell and the corresponding base station can be similar to the distance between the edge of a neighboring cell and that corresponding base station. As such, when a mobile device transitions from a first cell to a second cell of similar area, the conditions for communication with each base station can be similar enough that the quality of the communications links will also be similar and the user experience can be more seamless during the transition between cells.

Poorly balanced cell coverage areas can be associated with poor quality user experience and increased operational costs. As an example, a cell that is grossly larger than other cells in a RAN can provide a significantly lower signal-to-noise ratio (SNR) than the other cells in the RAN and communications links with that cell can be of lower quality. Similarly, communications with the larger cell can require higher transmit power levels, more frequent resending of lost packets, etc., and can therefore experience decreased battery life as compared with other cells of the RAN. Additionally, where mobile devices are built to be employed in RAN environments with evenly sized cells, an anomalous large sized cell can be associated with failed attempts to establish communications links because the communications link conditions exceed the design parameters of the mobile device which, for example, can result in high numbers of dropped calls, etc. It can be desirable to have knowledge of the coverage areas for base stations associated with cells in a RAN to allow correction of undesirable coverage conditions, to aid in layout planning for the RAN, etc.

Conventionally, RAN coverage conditions can be studied in a non-automated manner, such as by deploying personnel to go out into the field to measure SNR values across portions of the RAN. Further, collected measurements can be manually subjected to analysis techniques to determine information, such as an SNR map of the RAN, which can then separately be employed in adaptation of the RAN or planning deployment of resources to improve the performance of the RAN. Moreover, conventional techniques can generally not be adapted to modern decentralized control processes that are becoming increasingly common in RAN operations, e.g., Long Term Evolution (LTE) cellular technologies can specify substantially more decentralized operations, such as Automatic Neighbor Relations (ANR) at each eNodeB, than preceding cellular technologies. As such, it can be desirable to provide tools that can determine information that can be employed in adapting coverage area conditions in a more automated manner and can be applied in a more decentralized control environment.

### BRIEF DESCRIPTION OF DRAWINGS

FIG. 1 is an illustration of a system that facilitates timing advance analysis for adapting neighbor relations in accordance with aspects of the subject disclosure.

FIG. 2 is a depiction of a system that facilitates timing advance analysis and neighbor relations analysis for adapting neighbor relations in accordance with aspects of the subject disclosure.

FIG. 3 illustrates an example system that facilitates timing advance analysis of one or more timing advance conditions for adapting neighbor relations in accordance with aspects of the subject disclosure.

FIG. 4 is a graphic of timing advance measurement features in accordance with aspects of the subject disclosure.

FIG. 5 illustrates a method facilitating timing advance analysis for adapting neighbor relations in accordance with aspects of the subject disclosure.

FIG. 6 illustrates a method facilitating timing advance analysis and neighbor relations analysis for adapting neighbor relations in accordance with aspects of the subject disclosure.

FIG. 7 illustrates a method for facilitating timing advance analysis of one or more timing advance conditions for adapting neighbor relations in accordance with aspects of the subject disclosure.

FIG. 8 illustrates a method facilitating timing advance analysis and neighbor relations analysis for planning neighbor relations in accordance with aspects of the subject disclosure.

FIG. 9 is a block diagram of an example embodiment of a mobile network platform to implement and exploit various features or aspects of the subject disclosure.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Adjusting RAN performance by adapting cell coverage area can help optimize the operating efficiency of a wireless network. As an example, adjusting a first NodeB/eNodeB to cover a smaller region and a neighboring NodeB/eNodeB to cover a correspondingly larger region, e.g., balancing the coverage area of the first and second cells, can effectively shift loading of the RAN from the first NodeB/eNodeB to the neighboring NodeB/eNodeB. This can help load balance a RAN. As a second example, where an unplanned outage of a base station, e.g., a NodeB/eNodeB, occurs, adjusting nearby base station coverage areas can mitigate the effects of the outage. As a third example, scheduled based station service can be shifted to higher use times by shifting loads to other base stations where nearby base stations can be adjusted to provide adequate coverage while the first base station is being serviced.

Determining poor RAN coverage areas can facilitate adjustment of base station coverage areas. Base station coverage areas can be monitored, for example, to facilitate adjusting coverage areas to mitigate a planned or unplanned loss of a NodeB from the RAN. Further, integration with planning components and management components can be employed, for example, to anticipate future deployment of base stations to improve coverage areas, prioritization of base stations to improve coverage balance, etc. Historical information on coverage area patterns of base stations in a RAN can be employed, for example, to perform analysis of statistical coverage conditions for cells in a RAN, analysis of coverage areas as they relate to performance metrics, analysis of coverage areas with regard to specific event such as handovers, etc.

Mobile reporting components, e.g., user equipments (UEs), can be used to measure coverage areas. UEs operating in modern wireless radio communications environments employ Timing Advance (TA) techniques. TA techniques attempt to correct transmission windows to reduce or prevent the collision of data in the air portion of a communications link. Where two or more UEs transmit data at similar times and on the similar frequencies, the data can collide and be degraded. As such, each UE can be assigned a distinct timing window in which it can transmit data so as not to overlap the other UEs on similar frequencies. Where the distance a transmitted signal traverses increases, the propagation time for the traversal also increases. If the propagation time increases sufficiently, the timing windows can begin to overlap because the longer propagation time effectively retards the time of arrival at the receiver sufficiently so as to cause it to arrive in a similar time frame as another transmit window at a different distance and thus different propagation time. By measuring the propagation time for UEs, modern wireless environments can correct the timing of the transmission windows such that they arrive at the receiver at an expected time to avoid collision with other similarly corrected transmission windows. The measurement of the propagation time thus enables the use of a timing advance to correct transmission windows for distance from a receiver. This TA information can be measured for each UE in a RAN with regard to one or more base stations. The TA information, while including information about a timing correction, can effectively measure distances between a UE and a base station given that the timing correction is generally proportional to the distance between the UE and the base station. As an aside, TA information in systems employing active equipment between the UE and base station can impact the relation between TA and distance, e.g., a repeater can cause the UE to appear farther from the base station than it actually is, however, this active equipment can be rare in RANs and can be detected and accounted for within the scope of the present disclosure.

The use of TA information can indirectly provide insight into the coverage area of a base station in addition to the conventional use of TA information to adjust timing of transmission windows in wireless radio environments. Using TA information to analyze coverage area of a base station can help determine coverage area conditions without the need to deploy personnel to map coverage area manually as in conventional technologies. Further, the automated collection of TA information to analyze RAN coverage conditions can facilitate adaptation of a RAN based on the TA information. In an aspect, adaptation of the RAN can include prioritization of base stations in neighbor relations technologies, e.g., Automatic Neighbor Relation (ANR) detection for self-organizing networks (SON) in Long Term Evolution (LTE) wireless radio technologies, etc. This can apply to ranking new potential neighbors. This can also apply to ranking existing neighbors, e.g., for retention, deletion, etc. Moreover, TA information can be employed in instantaneous or historical modes, for example, to look at instant TA distributions for a base station or, as another example, to look at historical TA distributions for a base station, e.g., the last 24-hours, the last week, the last month, a week over week evolution of TA distribution, etc. Furthermore, TA information can be correlated to events, as examples, TA information for a UE related to a handover event between base stations, TA information for a UE related to an ANR request event, etc. Still further, TA information can be employed in RAN planning systems to promote evolution of RAN coverage according to one or more rules. Similarly, TA information can be employed for other purposes such as throwing alerts when RAN coverage diverges sufficiently from established parameters, deployment of maintenance services, sourcing information employed in automated mechanical adjustment of elevation, azimuth, or transmit power levels of base stations, etc., without departing from the present scope of the disclosure. The analysis of TA information can facilitate decentralized control processes that are expected to become more common as wireless radio control systems evolve, such as facilitating the analysis of TA information at individual eNodeBs in an LTE technology that can facilitate various aspects of a SON including self-healing and self-optimization by cooperation between eNodeBs decreased or no centralized control.

The following presents a simplified example embodiments of the disclosed subject matter in order to provide a basic understanding of some aspects of the various embodiments. This is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an embodiment, a system can include a processor and memory. The processor can facilitate the execution of computer-executable instructions stored on the memory. The execution of the computer-executable instructions can cause the processor to receive timing information related to a timing advance for a wireless communications system. The processor can further determine a value, based on the timing information, to facilitate adaptation of a coverage area of the wireless communication system and facilitate access to the value.

In another embodiment, a method can include receiving, by a system including a processor, radio area network information correlated to a timing advance characteristic of a wireless device of a radio area network. Based on the radio area network information a value can be determined to facilitate adapting a coverage area of the radio area network, wherein the adaptation of the coverage area can include adaptation of a neighbor relation characteristic. The method can further include facilitating access to the value.

In a further embodiment, a device of a base station such as an enhanced NodeB (eNodeB) can include a memory storing computer-executable instructions and a processor that facilitates execution of the computer-executable instructions. These instructions can cause the processor to receive a timing advance value related to a propagation delay between a user equipment and the device. The processor can further determine a value, based on the timing advance value, to facilitate adapting a coverage area of a wireless communications network including modification of an entry in a neighbor relation data structure, wherein the entry corresponds to a neighbor base station of the wireless communications network. Access to the value can facilitate adaptation of the topology of the wireless communications network. In an aspect, neighbor relations between base stations can relate to neighbor relations between sector carriers of the base stations. Sector carriers can include one or more radios embodying one or more radio access technologies. Further, sector carriers can include one or more radios operating at one or more frequencies. A radio can include one or more antenna. As such, sector carriers of a base station can be separately associated with neighbor relations information associated with a relationship between said sector carriers. As an example, base station “A” can serve several sectors, such as sectors 1 to 3. A second base station, “B”, can serve several sectors, such as sectors 4 to 9. Neighbor relations can be between the radios of the base stations serving specific sectors, for example, between the radios serving sector A-2 (base station A, sector 2) and sector B-9 (base station B, sector 9), etc. In some embodiments, neighbor relations information for a base station can include, for example, neighbor relations information for one or more sector carrier pairs.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

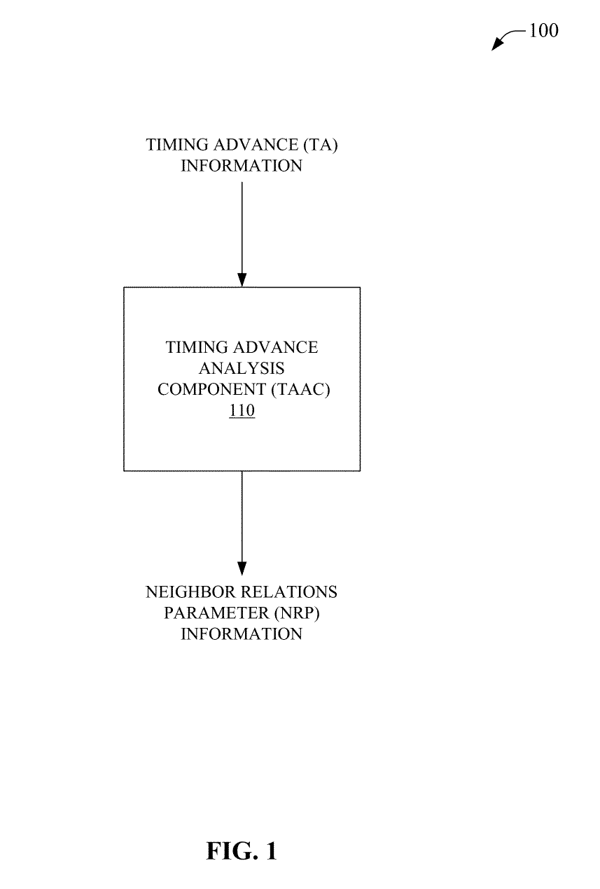

FIG. 1 is an illustration of a system 100, which facilitates timing advance analysis for adapting neighbor relations in accordance with aspects of the subject disclosure. System 100 can include timing advance (TA) analysis component (TAAC) 110. TAAC 110 can receive TA information for analysis. TA information can include UE identifier information, time shift information related to propagation time between a UE and a base station, distance information related to propagation time between a UE and a base station, or other types of information related to timing advance schemes. The analysis can result in a determination of neighbor relations parameter (NRP) information. NRP information can include TA distribution information, ranked lists of base stations based on TA information, distance distribution information determined form TA information, or other information derived from an analysis of TA information. TAAC 110 can further facilitate access to NRP information, such as by facilitating access to NRP information by ANR components, facilitating storage of NRP information for future access by other systems or components, etc.

In an aspect, TAAC 110 can analyze TA information based on one or more rules. As an example, analysis can include a rule for generating TA distribution information as a function of a target TA value. Where the target TA value is a predetermined time value, the distribution can be, for example, by percentage of the predetermined value. As an example, where the predetermined time is 1×10⁻⁵ sec, equivalent to an electromagnetic wave traveling about 3 kilometers in distance. A TAAC 110 analysis of TA information can then include a distribution of TA values for UEs being served by the corresponding base station, e.g., an eNodeB, as a percentage of the predetermined time, which can approximate a percentage of the distance between the UEs and the base station. For these types of distribution analyses, distribution patterns that are relatively confined to low values can indicate that most UEs are near to the base station. In contrast, TAs that are widely distributed over both low and high values can indicate that the base station is overshooting and serving too great an area relative to the area of other cells.

Similarly, where the target TA value is a measured time value rather than a predetermined time value, the analysis can provide a determination of TA distribution relative to the measured target TA value. As an example, where the target TA value is the maximum measured TA time value for the base station in the last 24 hours (maxTA24), then other TA time values can employed in an analysis to determine their distribution as a percentage of maxTA24. This type of analysis can indicate the concentration of UEs across the area typically served by a base station such that a more even distribution indicates more uniform access to the base station with the service area and less even distribution can indicate higher access regions that can suggest areas of importance in future expansion of the RAN infrastructure, such as deployment of future base stations.

In an aspect, TAAC 110 analysis can include threshold levels. Threshold levels can be predetermined, for example, a 90%, a 50%, and a 10% threshold can indicate the number of UEs within 90% of the target TA value, 50% of the target TA value, and 10% of the target TA value respectively. Threshold values can be easily employed as NRP information in comparing multiple base stations. As an example, where a first base station regularly has high values in the 90% threshold and low values in the 50% threshold, this can indicate that there are many UEs in the 50-90% range, which can indicate that there are many UEs farther from the base station than other comparative base stations with low values in the 50-90% range. As a further example, where two neighboring base stations show high values in the 50-90% range for the first base station and high values only under the 10% threshold for the second base station, this can indicate that the area of the first base station is larger than the second base station and that correction can be beneficial to balance the two coverage areas better.

As an example of another rule, TAAC 110 can determine NRP information based on TA information related to specific events, such as a handover event, an ANR request event, etc. As an example, in a handover event, TA information can include TA value(s) for an outgoing UE before handover, TA value(s) for an incoming UE before handover, TA value(s) for an outgoing UE after handover, TA value(s) for an incoming UE after handover, TA value(s) for an outgoing UE at handover, TA value(s) for an incoming UE at handover, etc. An analysis can indicate relative coverage areas of the outgoing and incoming base stations. Further, an analysis can determine a specific value indicating the difference between the incoming and outgoing TA values (TA delta) that can indicate coverage area imbalance. Typically handovers occur near equidistant from each base station, e.g., about midway between two base stations, and would be associated with similar TA values where the base station coverage areas are also similar. Thus, where TA delta is large, this can indicate a coverage imbalance. As an example, where a first base station and second base station are 10 km apart, the handover can typically be expected at around 5 km where the UE is traversing a line between the two base stations. A 5 km distance can be associated with a TA value of about 17,000 nsec such that both the first and second base station when handing over at 5 km would have a 17,000 nsec TA value and the TA delta would be near zero. In contrast, where the first base station has a coverage area of 8 km, about 27,000 nsec propagation time, and the second base station has a coverage area extending to about 2 km, about 7,000 nsec propagation time, the handover can actually occur at about the edges of the coverage areas. Thus, the first base station can have a TA value of near 27,000 nsec at 8 km and the second base station can have a TA value near 7,000 nsec at 2 km. As such, a TA delta can be approximately 20,000 nsec and can reflect the relative imbalance in the coverage areas.

In a further aspect, the TAAC 110 analysis, such as the TA delta values, of many handover events can be employed to determine a ranking of neighboring base stations to improve the balance in coverage area among the base stations while still providing coverage. This ranking can be based on one or more ranking rules and, in an embodiment, can be performed by TAAC 110, such that the NRP information includes resulting rank information for base stations. In another embodiment, NRP information can be analysis results, such as TA delta values, that can be employed in ranking external to TAAC 110.

TAAC 110 analysis relative to an ANR request event can include TA values relative to detecting and reporting a potential neighboring base station where an ANR request can be forthcoming. In an aspect, where a new base station comes online, a UE can encounter the new base station and report it to current eNodeBs on the UE neighbor list. TA information can be captured and associated with this event. The TA information can reflect the distance of the UE from the serving base station when the new base station is detected. This information can be analyzed to indicate various conditions. As an example, where the new base station is detected when the TA value is in the 50-90% range of the serving base station, this can indicate that the new base station can actually be an existing neighbor that dropped offline temporarily and has come back online based on the serving base station having large TA values that can be associated with serving a greater area than it normally might. Conversely, for example, where the new base station event occurs while the serving base station is under the 10% range, this can indicate that the new base station is being added near to the serving base station and that rebalancing of the coverage areas may be desirable. Further, the example addition of a new nearby base station can trigger an automated readjust of rankings in ANR lists such that more distant base stations are deprioritized or marked for deletion in view of the new closer base station.

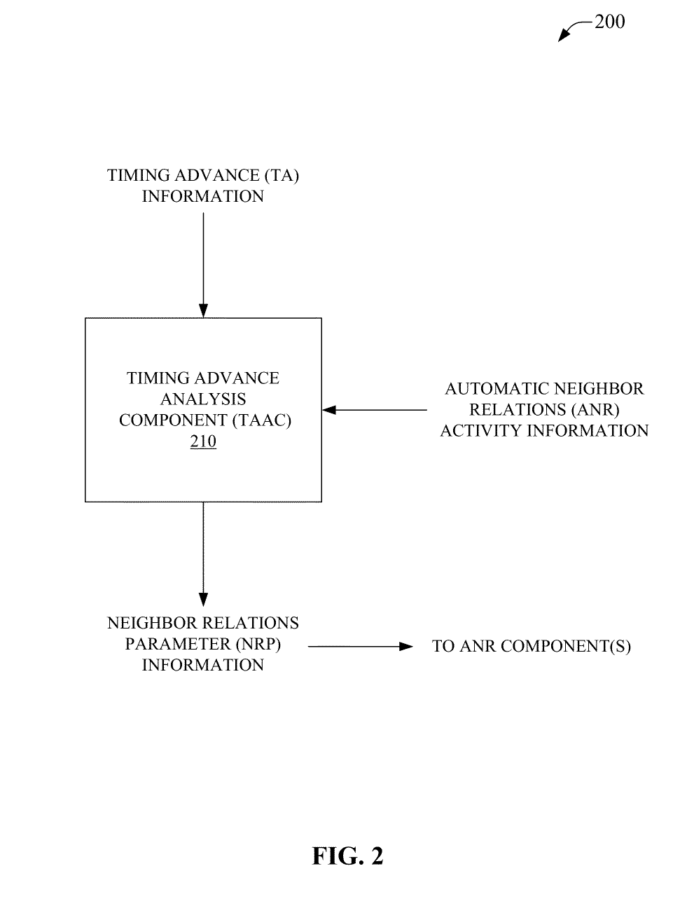

FIG. 2 is a depiction of a system 200 that can facilitate timing advance analysis and neighbor relations analysis for adapting neighbor relations in accordance with aspects of the subject disclosure. System 200 can include TAAC 210 that can receive TA information for analysis and can further receive ANR activity information for analysis. The analysis can result in a determination of neighbor relations parameter (NRP) information. TAAC 210 can further facilitate access to NRP information.

In an aspect, TAAC 210 can analyze TA information and ANR activity information based on one or more rules. As an example, analysis can include a rule for generating TA distribution information as a function of a target TA value for base stations in an ANR neighbor list. As a second example, analysis can include a rule for ranking base stations of an ANR neighbor list based on threshold TA values, such as to rank base stations with similar coverage areas higher than base stations with more divergent coverage areas. ANR activity information can include an ANR neighbor list, or part thereof, base station identifier(s), ANR ranking or priority values for base station(s), historical information relating to ANR neighbor lists, etc. NRP information can include results from the TAAC 210 analysis, such as distribution information, ranked lists of base stations, etc. NRP information can be received by ANY component(s) to facilitate ANR processes such as adding or deleting neighbors from neighbor relations lists. This can facilitate SON features such as self-healing, self-optimization, etc. in RAN environments with low levels of centralized control in comparison more traditional RAN environments, e.g., 3^{rd} generation (3G) mobile telecommunications technology, etc.

In an aspect, the inclusion of ANR activity information can provide information to generate analysis that is more relevant to the ANR process and can be more streamlined than the analysis provided by TAAC 110. As an example, where ANR activity information includes a list of base stations in the neighbor relations list, TAAC 210 can perform analyses relevant to just the base stations on the list and can avoid processing analyses for other base stations unless specifically indicated. Similarly, analysis can be limited to a subset of the set of base stations comprising an ANR list, such as the three nearest neighbors to a serving base station, to reduce processing time and consumption of computing resources.

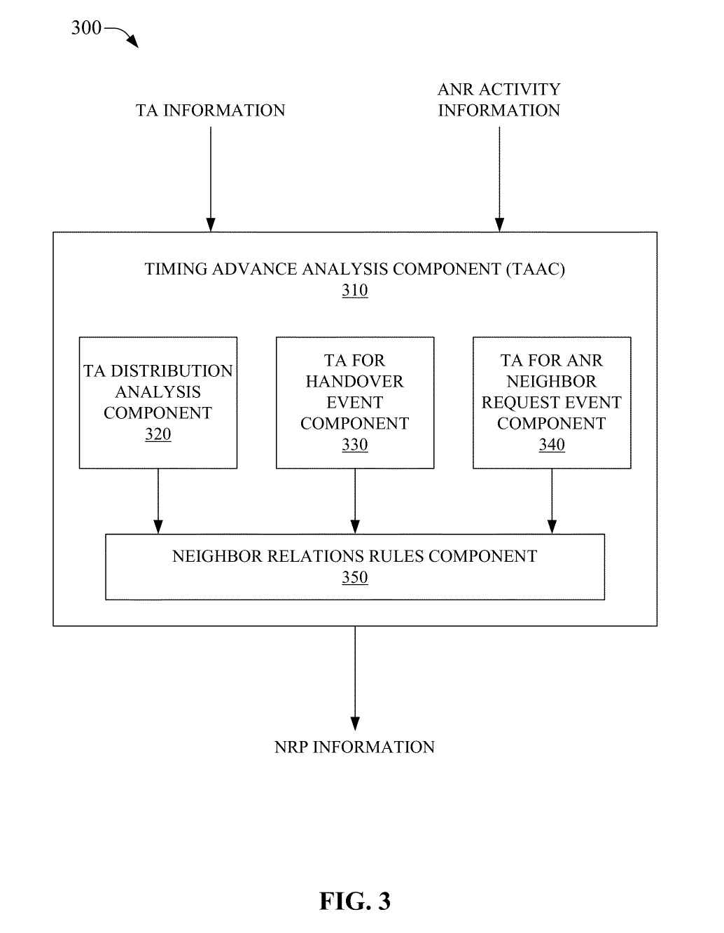

FIG. 3 illustrates a system 300 that facilitates timing advance analysis of one or more timing advance conditions for adapting neighbor relations in accordance with aspects of the subject disclosure. System 300 can include TAAC 310. TAAC 310 can receive TA information for analysis and can further receive ANR activity information for analysis. The analysis can result in a determination of NRP information. TAAC 310 can further facilitate access to NRP information.

TAAC 310 can include TA distribution analysis component 320. TA distribution analysis component 320 can determine distribution of TA information, including TA timing values. In an aspect, distribution can be relative to a predetermined time value. The predetermined time value can be related to a predetermined distance associated with a base station coverage area value. As an example, where a base station coverage area is expected to extend no more than about 9 km radially from the base station, a predetermined time value of 3×10⁻⁵ seconds can be employed, correlating approximately to the propagation time of an electromagnetic wave across 9 km. As such, measured TA values from UEs can be distributed relative to the expected perimeter of a base station coverage area at about 9 km. Distributions that are comparatively small and narrowly distributed can indicate that the associated served UEs are relatively near the base station while, in contrast, a wide distribution with larger numbers of TA values near the 3×10⁻⁵ seconds value can indicate that a base station is serving many UEs near the expected edge of a coverage area. Where many TA values exceed the 3×10⁻⁵ seconds range, this can indicate that the base station is covering a much wider coverage area than expected and can indicate areas of concern in the RAN deployment. This information can be employed by RAN planning tools, error mitigation tools, ANR tools, etc., to adjust the RAN to attempt to improve the RAN deployment.

In a further aspect, TA distribution analysis component 320 can include threshold level analysis. Threshold level analysis can be relative to predetermined threshold levels, for example, a 99.9%, a 99, a 95%, and a 65%, threshold can indicate the number of UEs within 99.9% of the target TA value, 99% of the target TA value, 95% of the target TA value, and 65% of the target TA value respectively. Threshold values can be employed as NRP information.

TAAC 310 can include TA for handover event component 330. TA for handover event component 330 can analyze TA information relative to a handover event. In a handover event, TA information can be captured for the UE before handover, at handover, and after handover, for the UE relative to the outgoing and incoming base station. As such, TA information can include TA value(s) for an outgoing UE before handover, TA value(s) for an incoming UE before handover, TA value(s) for an outgoing UE after handover, TA value(s) for an incoming UE after handover, TA value(s) for an outgoing UE at handover, TA value(s) for an incoming UE at handover, etc. An analysis can indicate relative coverage areas of the outgoing and incoming base stations. Further, an analysis can determine a specific value indicating the difference between the incoming and outgoing TA values (TA delta) that can indicate coverage area imbalance. Typically handovers occur near equidistant from each base station, e.g., about midway between two base stations, and would be associated with similar TA values where the base station coverage areas are also similar. Thus, where TA delta is large, this can indicate a coverage imbalance. TA delta values can be employed to determine a ranking of neighboring base stations to improve the balance in coverage area among the base stations. This ranking can be based on one or more ranking rules.

TAAC 310 can include TA neighbor request event component 340. TA neighbor request event component 340 can analyze TA information relative to a new neighbor base station being detected. As new base stations come online, a UE can encounter the new base stations and report them to serving eNodeBs. TA information can be captured and associated with this event. The TA information can reflect the distance of the UE from a serving base station when a new base station is detected. This information can be analyzed to indicate various conditions including base stations that have gone offline temporarily, new base stations that can provide improved coverage conditions, etc.

TAAC 310 can include neighbor relations rules component 350. Neighbor relations rules component 350 can receive the results of the analysis from a component of TAAC 310, such as TA distribution analysis component 320, TA for handover event component 330, TA neighbor request event component 340, etc., and can employ rules relating to neighbor relations lists to facilitate the determination of NRP information. Neighbor relations rules component 350 can apply rules including sorting rules, ranking rules, flagging/marking rules, addition rules, deletion rules, etc., to determine a NRP information based on the analysis of TA information performed by components of TAAC 310. As an example, ranking rules can be applied by way of neighbor relations rules component 350 to TA distribution information generated by TA distribution analysis component 320 from received TA information. These example ranking rules can facilitate determining NRP information that relates to the ranking of base stations for a neighbor relations list. In particular, where ANR activity information is also received by TAAC 310, the NRP information can relate to a particular set or subset of ANR neighbor relations. In a more specific example, ANR activity information can indicate a target set of base stations such that the TA information for the base stations of the target set can be analyzed for a handover event, by way of TA for handover event component 320, to facilitate ranking, by applying a ranking rule at neighbor relations rules component 350, the target set of base stations to improve the balance of the coverage areas of the target set of base stations. This ranking can include marking, by applying a marking rule at neighbor relations rules component 350, base stations of the target set of base stations for deletion, etc. so as to adjust the priority with which the remaining base stations (or newly added base stations by way of TA for ANR neighbor request event component 340) are employed in a RAN environment that self-organizes.

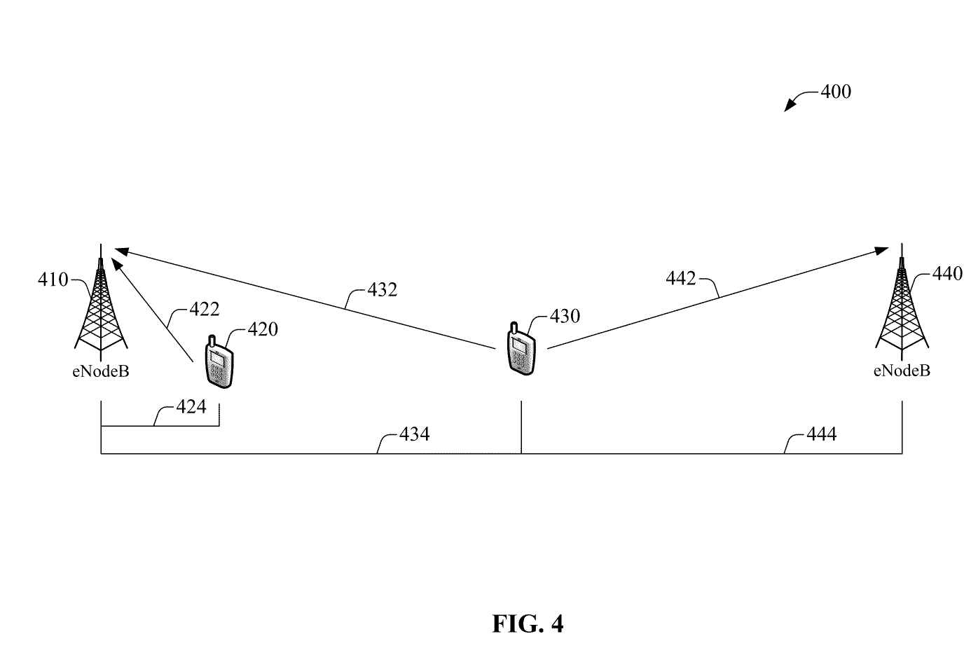

FIG. 4 is a graphic 400 of timing advance measurement features in accordance with aspects of the subject disclosure. Example graphic 400 illustrates two base stations, eNodeB 410 and 440. eNodeB 410 can serve UE 420 and UE 430. UE 420 can be distance 424 from eNodeB 410. Distance 424 can be generally be related to a propagation time 422. Propagation time 422 can be employed to offset transmission windows for wireless communication between UE 420 and eNodeB 410 by a first timing advance (TA) value. Similarly, UE 430 can be distance 434 from eNodeB 410. Distance 434 can generally correlate to a propagation time 432. Propagation time 432 can be employed to offset transmission windows for wireless communication between UE 430 and eNodeB 410 by a second TA value. Of note, where distance 424 and 434 are dissimilar, the first TA value and second TA value can also be dissimilar. Moreover, UE 430 can be distance 444 from eNodeB 420. Distance 444 can be generally related to a propagation time 442. Propagation time 442 can be employed to offset transmission windows for wireless communication between UE 430 and eNodeB 440 by a third TA value. Of note, where distance 444 and 434 are similar, the third TA value and second TA value can also be similar, though they are associated with different serving UEs.

In an aspect, UE 420 can be expected to have a lower TA value than UE 430 with regard to eNodeB 410 because UE 420 is closer to eNodeB 410 than UE 430. Further, where distance 434 and distance 444 are similar, UE 430 can be expected to have a similar TA with regard to eNodeB 410 and eNodeB 440. Analysis of the TA values for UE 430 can indicate that the coverage area of eNodeB 410 and eNodeB 440 are relatively balanced given similar TA values.

In a further aspect, a handover event, for example for UE 430 from eNodeB 410 to eNodeB 440, can determine that the serving area of eNodeB 410 and eNodeB 440 are comparable where an analysis of the TA for UE 430 at handover occurs with propagation time 432 and 442 reflecting distances 434 and 444.

Moreover, if eNodeB 440 is being detected as a new neighbor by UE 430, then the similarity in TA values corresponding to the similarity in distances 434 and 444, can indicate that the coverage area of eNodeB 440 is similar to the coverage area of eNodeB 410 and that this can increase the preference of employing eNodeB 440 as a neighbor by way of ANR mechanisms for UEs served by eNodeB 410.

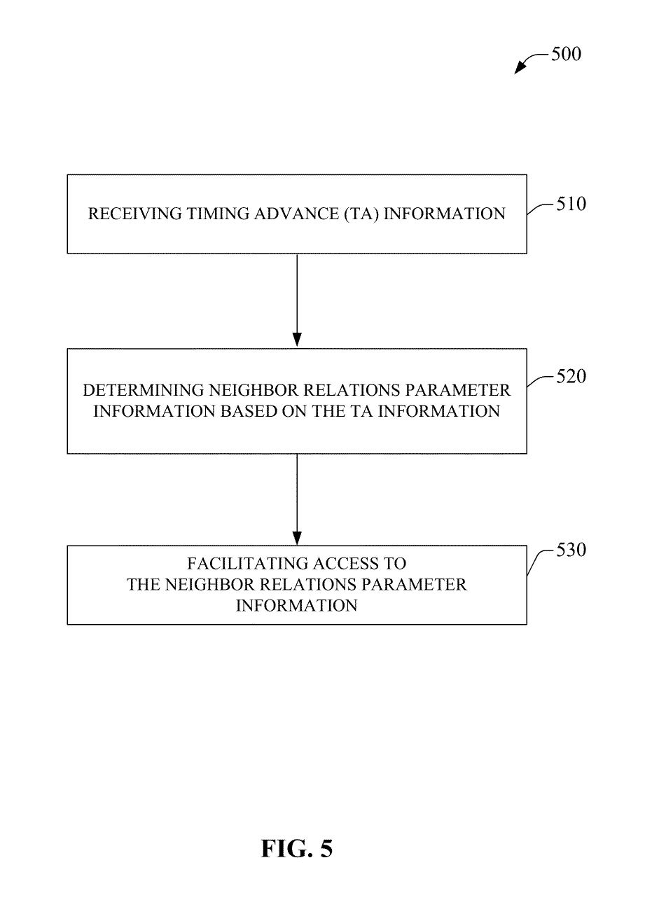

In view of the example system(s) described above, example method(s) that can be implemented in accordance with the disclosed subject matter can be better appreciated with reference to flowcharts in FIG. 5-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 5 illustrates aspects of method 500 facilitating timing advance analysis for adapting neighbor relations in accordance with aspects of the subject disclosure. At 510, timing advance (TA) information can be received. TA information can include UE identifier information, time shift information related to propagation time between a UE and a base station, distance information related to propagation time between a UE and a base station, or other types of information related to timing advance schemes.

At 520, neighbor relations parameter (NRP) information can be determined. NRP information can be determined based on the TA information received at 510. NRP information can include TA distribution information, ranked lists of base stations based on TA information, distance distribution information determined form TA information, or other information derived from an analysis of TA information.

At 530, method 500 can facilitate access to the determined NRP information. Access to NRP information can include access by Automatic Neighbor Relation (ANR) detection for self-organizing networks (SON) in Long Term Evolution (LTE) wireless radio technologies, etc., access by system components, facilitating storage of NRP information for future access by other systems or components, etc. At this point, method 500 can end

In an aspect, method 500 can provide for analyzing TA information based on one or more rules in determining NRP information. As an example, analysis can include a rule for generating TA distribution information as a function of a target TA value. A target TA value can be a predetermined time value such that the distribution can be, for example, by percentage of the predetermined target TA value. As such, in the example, the TA information received at 510 can include a distribution of TA values for UEs being served by a corresponding base station, e.g., an eNodeB, as a percentage of the predetermined target TA time, which can approximate a percentage of the distance between the UEs and the base station. For these types of distribution analyses, distribution patterns that are relatively confined to low values can indicate that most UEs are near to the base station. In contrast, TAs that are widely distributed over both low and high values can indicate that the base station can be overshooting and serving a disproportionately large area relative to the area of other cells. In a similar aspect, the target TA value can be a measured time value rather than a predetermined time value such that the analysis can provide a determination of TA distribution relative to the measured target TA value. In a further aspect, the determining NRP information can be related to threshold levels. Threshold levels can be predetermined, for example, a 90%, a 50%, and a 10% threshold can be related to a threshold value indicating the number of UEs within 90% of the target TA value, 50% of the target TA value, and 10% of the target TA value respectively. Threshold values can be NRP information in comparing multiple base stations.

In other aspects, determining NRP information can be related to specific events, such as a handover event, an ANR request event, etc. In an example handover event, TA information received at 510 can include a TA value for an outgoing UE before handover, a TA value for an incoming UE before handover, a TA value for an outgoing UE after handover, a TA value for an incoming UE after handover, a TA value for an outgoing UE at handover, a TA value for an incoming UE at handover, etc. Determining, at 520, can indicate relative coverage areas of the outgoing and incoming base stations. Further, an analysis can determine a specific value indicating the difference between the incoming and outgoing TA values (TA delta) that can indicate coverage area imbalance. Typically handovers can occur near equidistant from each base station, e.g., about midway between two base stations, and would be associated with similar TA values where the base station coverage areas are also similar. Thus, where TA delta is large, this can indicate a coverage imbalance. Moreover, the TA delta values, of many handover events can be employed in determining a ranking of neighboring base stations.

In a further aspect, determining NRP information can relate to an ANR request event can include TA values relative to detecting and reporting a new neighboring base station. Where a new base station comes online, a UE can encounter the new base station and report it to a serving eNodeBs. TA information can be captured and associated with this event. The TA information can be related to the distance of the UE from the serving base station when the new base station is detected. This information can be analyzed to indicate various conditions within the scope of method 500. As an example, where the new base station is detected and correlated with high TA values for the serving base station, determined NRP information, at 520, can indicate that the new base station can be a temporarily offline base station returning to an online status wherein the current serving base station is serving a larger area than would be typically expected. Conversely, for example, where the new base station event occurs while the TA values are low can indicate that the new base station is being added near to the serving base station and that rebalancing of the coverage areas may be desirable. The example addition of a new nearby base station can be associated with readjusting the rankings of ANR lists such that more distant base stations are deprioritized or marked for deletion in view of the new closer base station.

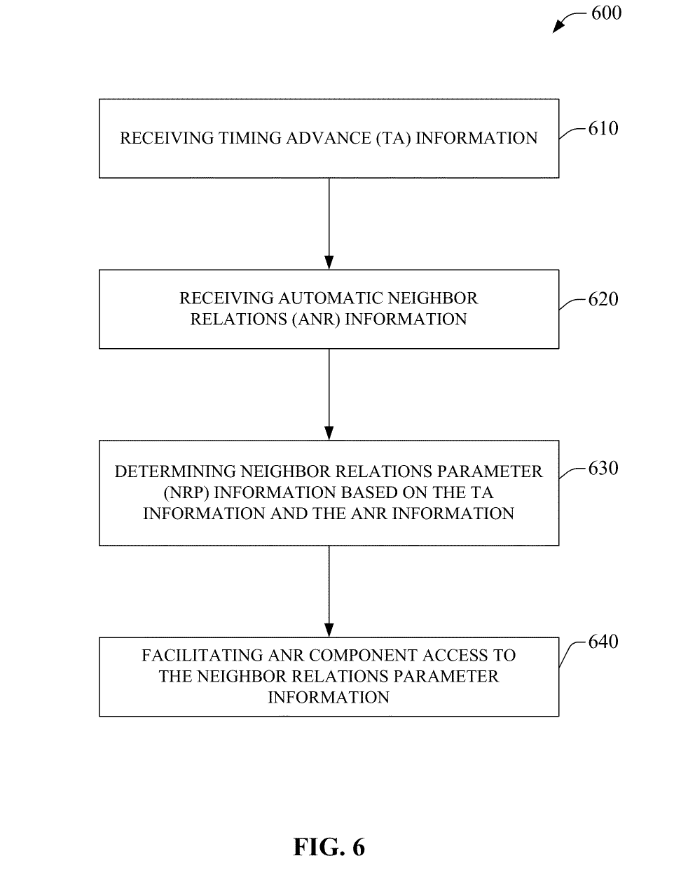

FIG. 6 illustrates aspects of method 600 facilitating timing advance analysis and neighbor relations analysis for adapting neighbor relations in accordance with aspects of the subject disclosure. At 610, TA information can be received. TA information can include UE identifier information, time shift information related to propagation time between a UE and a base station, distance information related to propagation time between a UE and a base station, or other types of information related to timing advance schemes.

At 620, ANR information can be received. ANR information can include an ANR neighbor list, or part thereof, base station identifier(s), ANR ranking or priority values for base station(s), historical information relating to ANR neighbor lists, etc. The inclusion of ANR information can provide information to facilitate determining NRP information that is relevant to the ANR process and can be more streamlined than the analysis provided in the absence of the ANR information. As an example, ANR information can include a list of base stations in a neighbor relations list such that the determining of NRP information can be constrained to the base stations on the list and can avoid extraneous analyses for other base stations. Similarly, analysis can be limited to a subset of the set of base stations comprising an ANR list to reduce processing time and consumption of computing resources to execute method 600.

At 630, NRP information can be determined. NRP information can be determined based on the TA information received at 610 and ANR information received at 620. NRP information can include TA distribution information, ranked lists of base stations based on TA information, distance distribution information determined form TA information, or other information derived from an analysis of TA information.

At 640, method 600 can facilitate access to the determined NRP information. At this point, method 600 can end

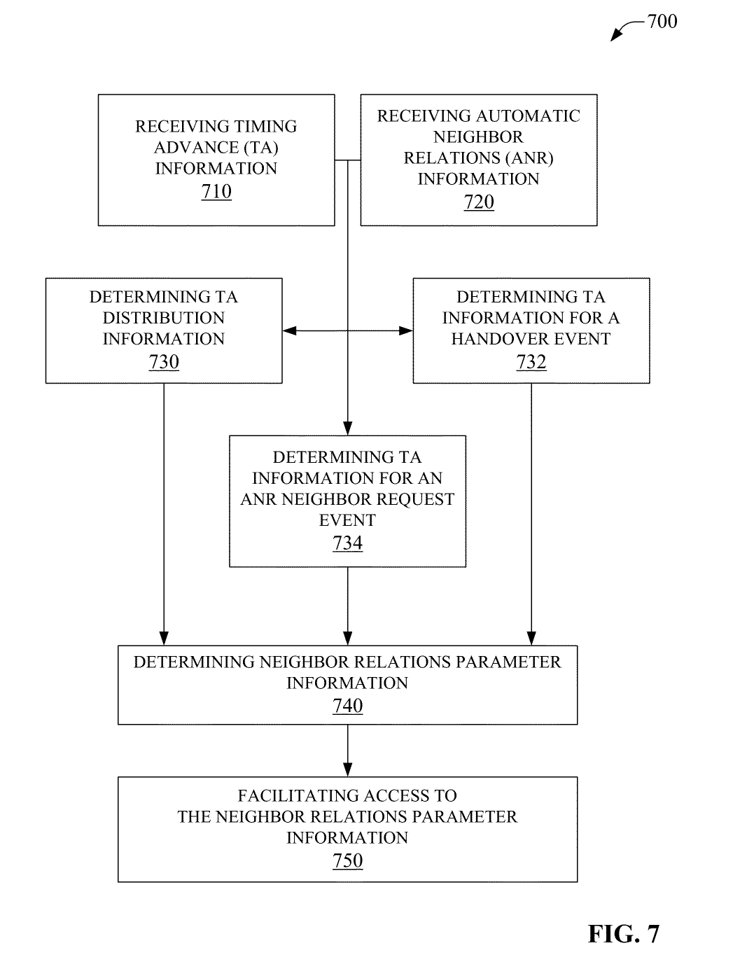

FIG. 7 illustrates a method 700 that facilitates timing advance analysis of one or more timing advance conditions for adapting neighbor relations in accordance with aspects of the subject disclosure. At 710, TA information can be received. TA information can include UE identifier information, time shift information related to propagation time between a UE and a base station, distance information related to propagation time between a UE and a base station, or other types of information related to timing advance schemes. At 720, ANR information can be received. ANR information can include an ANR neighbor list, or part thereof, base station identifier(s), ANR ranking or priority values for base station(s), historical information relating to ANR neighbor lists, etc. The inclusion of ANR information can provide information to facilitate determining NRP information that is relevant to the ANR process and can be more streamlined than the analysis provided in the absence of the ANR information.

At 730, method 700 can include determining distribution of TA information, including TA timing values. In an aspect, distribution can be relative to a predetermined time value. The predetermined time value can be related to a predetermined distance associated with a base station coverage area value. Distributions that are comparatively small and narrowly distributed can indicate that the associated served UEs are relatively near the base station while, in contrast, a wide distribution with larger numbers of high TA values can indicate that the base station is covering a much wider coverage area than expected and can indicate areas of concern in the RAN deployment. This information can be employed by RAN planning tools, error mitigation tools, ANR tools, etc., to adjust the RAN to attempt to improve the RAN deployment. In an aspect, determining TA distribution can include threshold level analysis. Threshold level analysis can be relative to predetermined threshold levels, for example, a 99.9%, a 99, a 95%, and a 65%, threshold can be associated with threshold values that indicate the number of UEs within 99.9% of the target TA value, 99% of the target TA value, 95% of the target TA value, and 65% of the target TA value respectively. Threshold values can be employed as NRP information at 740.

At 732, method 700 can include determining TA information relative to a handover event. In a handover event, TA information can be captured for a UE before handover, at handover, and after handover, for the UE relative to an outgoing and an incoming base station. As such, TA information can include TA values for an outgoing UE before handover, TA values for an incoming UE before handover, TA values for an outgoing UE after handover, TA values for an incoming UE after handover, TA values for an outgoing UE at handover, TA values for an incoming UE at handover, etc. Determining TA information for a handover event can indicate relative coverage areas of the outgoing and incoming base stations. This can include determining a specific value for the difference between the incoming and outgoing TA values (TA delta) that can indicate coverage area imbalance. Typically handovers occur near equidistant from each base station, e.g., about midway between two base stations, and would be associated with similar TA values where the base station coverage areas are also similar. Thus, where TA delta is large, this can indicate a coverage imbalance. TA delta values can be employed to determine a ranking of neighboring base stations to improve the balance in coverage area among the base stations. This ranking can be based on one or more ranking rules.

At 734, method 700 can include determining TA information relative to a new neighbor base station being detected. As new base stations come online, a UE can encounter the new base stations and report them to serving eNodeBs. TA information can be captured and associated with this event. The TA information can reflect the distance of the UE from a serving base station when a new base station is detected. This information can be analyzed to indicate various conditions including base stations that have gone offline temporarily, new base stations that can provide improved coverage conditions, etc.

At 740, NRP information can be determined. NRP information can be determined based on the TA information received at 710 and ANR information received at 720. NRP information can be further based on the TA distribution information determined at 730, the TA information for a handover event determined at 732, and/or the TA information for an ANR neighbor request determined at 734. NRP information can include TA distribution information, ranked lists of base stations based on TA information, distance distribution information determined form TA information, or other information derived from an analysis of TA information.

At 740, method 700 can facilitate access to the determined NRP information. At this point, method 700 can end.

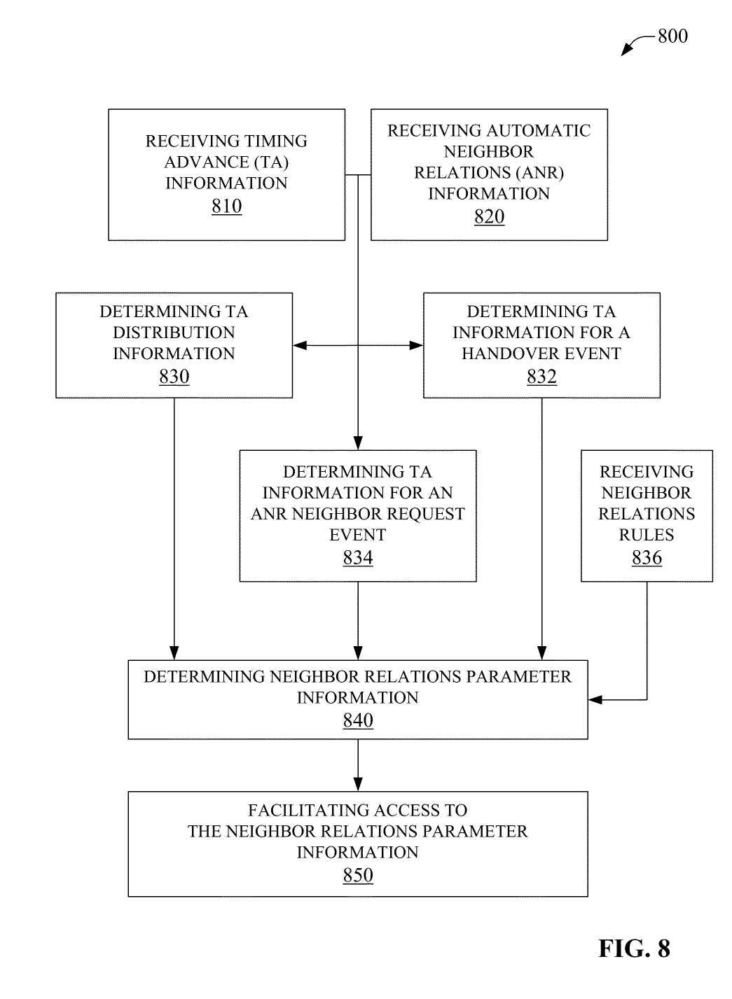

FIG. 8 illustrates a method 800 that facilitates timing advance analysis and neighbor relations analysis for planning neighbor relations in accordance with aspects of the subject disclosure. At 810, TA information can be received. TA information can include UE identifier information, time shift information related to propagation time between a UE and a base station, distance information related to propagation time between a UE and a base station, or other types of information related to timing advance schemes. At 820, ANR information can be received. ANR information can include an ANR neighbor list, or part thereof, base station identifier(s), ANR ranking or priority values for base station(s), historical information relating to ANR neighbor lists, etc. The inclusion of ANR information can provide information to facilitate determining NRP information that is relevant to the ANR process and can be more streamlined than the analysis provided in the absence of the ANR information.

At 830, method 800 can include determining distribution of TA information, including TA timing values. This information can be employed by RAN planning tools, error mitigation tools, ANR tools, etc., to adjust the RAN to attempt to improve the RAN deployment. In an aspect, determining TA distribution can include threshold level analysis. Threshold values can be employed as NRP information at 840.

At 832, method 800 can include determining TA information relative to a handover event. In a handover event, TA information can be captured for a UE before handover, at handover, and after handover, for the UE relative to an outgoing and an incoming base station. Determining TA information for a handover event can indicate relative coverage areas of the outgoing and incoming base stations. This can include determining TA delta that can indicate coverage area imbalance. Where TA delta is large, this can indicate a coverage imbalance. TA delta values can be employed to determine a ranking of neighboring base stations to improve the balance in coverage area among the base stations. This ranking can be based on one or more ranking rules.

At 834, method 800 can include determining TA information relative to a new neighbor base station being detected. As new base stations come online, a UE can encounter the new base stations and report them to serving eNodeBs. TA information can be captured and associated with this event. The TA information can reflect the distance of the UE from a serving base station when a new base station is detected. This information can be analyzed to indicate various conditions including base stations that have gone offline temporarily, new base stations that can provide improved coverage conditions, etc.

At 836, neighbor relations rules can be received. Neighbor relations rules can facilitate determining of NRP information. Neighbor relations rules can be related to prioritization techniques for ranking prospective ANR neighbors. As an example, a neighbor relations rule can be related to a preference for selecting neighbors that result in a particular granularity of coverage area in RAN cells. As another example, a neighbor relations rule can be related to a preference for selecting ANR neighbors that result in a more uniform cellular coverage area for each cell of a RAN.

At 840, NRP information can be determined. NRP information can be determined based on the TA information received at 810 and ANR information received at 820. NRP information can be further based on the TA distribution information determined at 830, the TA information for a handover event determined at 832, and/or the TA information for an ANR neighbor request determined at 834, subject to neighbor relations rules received at 836. NRP information can include TA distribution information, ranked lists of base stations based on TA information, distance distribution information determined form TA information, or other information derived from an analysis of TA information.

At 840, method 800 can facilitate access to the determined NRP information. At this point, method 800 can end

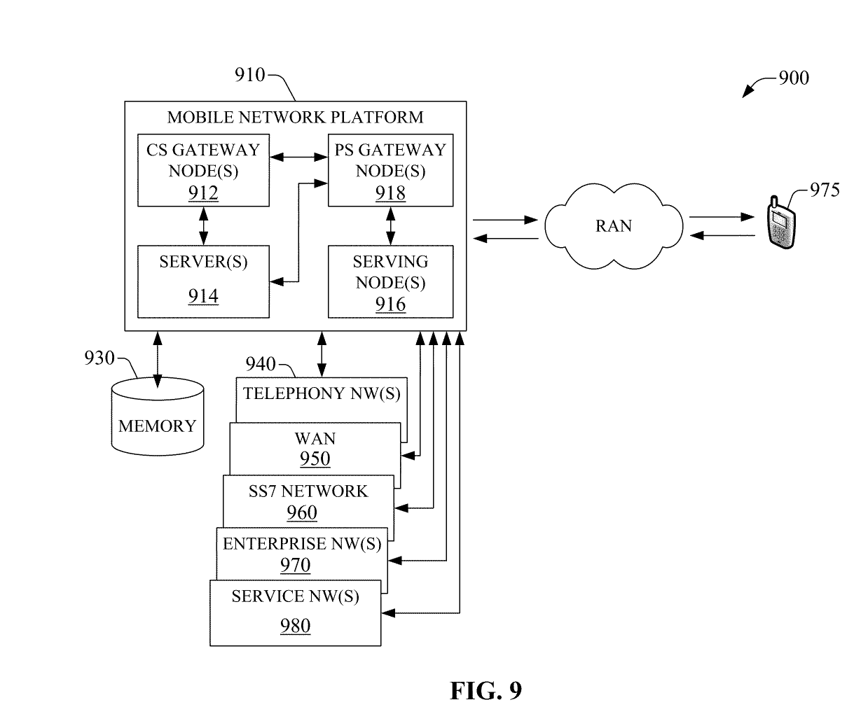

FIG. 9 presents an example embodiment 900 of a mobile network platform 910 that can implement and exploit one or more aspects of the disclosed subject matter described herein. Generally, wireless network platform 910 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, wireless network platform 910 can be included in telecommunications carrier networks, and can be considered carrier-side components as discussed elsewhere herein. Mobile network platform 910 includes CS gateway node(s) 912 which can interface CS traffic received from legacy networks like telephony network(s) 940 (e.g., public switched telephone network (PSTN), or public land mobile network (PLMN)) or a signaling system #7 (SS7) network 970. Circuit switched gateway node(s) 912 can authorize and authenticate traffic (e.g., voice) arising from such networks. Additionally, CS gateway node(s) 912 can access mobility, or roaming, data generated through SS7 network 970; for instance, mobility data stored in a visited location register (VLR), which can reside in memory 930. Moreover, CS gateway node(s) 912 interfaces CS-based traffic and signaling and PS gateway node(s) 918. As an example, in a 3GPP UMTS network, CS gateway node(s) 912 can be realized at least in part in gateway GPRS support node(s) (GGSN). It should be appreciated that functionality and specific operation of CS gateway node(s) 912, PS gateway node(s) 918, and serving node(s) 916, is provided and dictated by radio technology(ies) utilized by mobile network platform 910 for telecommunication.

In addition to receiving and processing CS-switched traffic and signaling, PS gateway node(s) 918 can authorize and authenticate PS-based data sessions with served mobile devices. Data sessions can include traffic, or content(s), exchanged with networks external to the wireless network platform 910, like wide area network(s) (WANs) 950, enterprise network(s) 970, and service network(s) 980, which can be embodied in local area network(s) (LANs), can also be interfaced with mobile network platform 910 through PS gateway node(s) 918. It is to be noted that WANs 950 and enterprise network(s) 960 can embody, at least in part, a service network(s) like IP multimedia subsystem (IMS). Based on radio technology layer(s) available in technology resource(s) 917, packet-switched gateway node(s) 918 can generate packet data protocol contexts when a data session is established; other data structures that facilitate routing of packetized data also can be generated. To that end, in an aspect, PS gateway node(s) 918 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 900, wireless network platform 910 also includes serving node(s) 916 that, based upon available radio technology layer(s) within technology resource(s) 917, convey the various packetized flows of data streams received through PS gateway node(s) 918. It is to be noted that for technology resource(s) 917 that rely primarily on CS communication, server node(s) can deliver traffic without reliance on PS gateway node(s) 918; for example, server node(s) can embody at least in part a mobile switching center. As an example, in a 3GPP UMTS network, serving node(s) 916 can be embodied in serving GPRS support node(s) (SGSN).

For radio technologies that exploit packetized communication, server(s) 914 in wireless network platform 910 can execute numerous applications that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 910. Data streams (e.g., content(s) that are part of a voice call or data session) can be conveyed to PS gateway node(s) 918 for authorization/authentication and initiation of a data session, and to serving node(s) 916 for communication thereafter. In addition to application server, server(s) 914 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 910 to ensure network's operation and data integrity in addition to authorization and authentication procedures that CS gateway node(s) 912 and PS gateway node(s) 918 can enact. Moreover, provisioning server(s) can provision services from external network(s) like networks operated by a disparate service provider; for instance, WAN 950 or Global Positioning System (GPS) network(s) (not shown). Provisioning server(s) can also provision coverage through networks associated to wireless network platform 910 (e.g., deployed and operated by the same service provider), such as femto-cell network(s) (not shown) that enhance wireless service coverage within indoor confined spaces and offload RAN resources in order to enhance subscriber service experience within a home or business environment by way of UE 975.

It is to be noted that server(s) 914 can include one or more processors configured to confer at least in part the functionality of macro network platform 910. To that end, the one or more processor can execute code instructions stored in memory 930, for example. It is should be appreciated that server(s) 914 can include a content manager 915, which operates in substantially the same manner as described hereinbefore.

In example embodiment 900, memory 930 can store information related to operation of wireless network platform 910. Other operational information can include provisioning information of mobile devices served through wireless platform network 910, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 930 can also store information from at least one of telephony network(s) 940, WAN 950, enterprise network(s) 960, or SS7 network 970. In an aspect, memory 930 can be, for example, accessed as part of a data store component or as a remotely connected memory store.

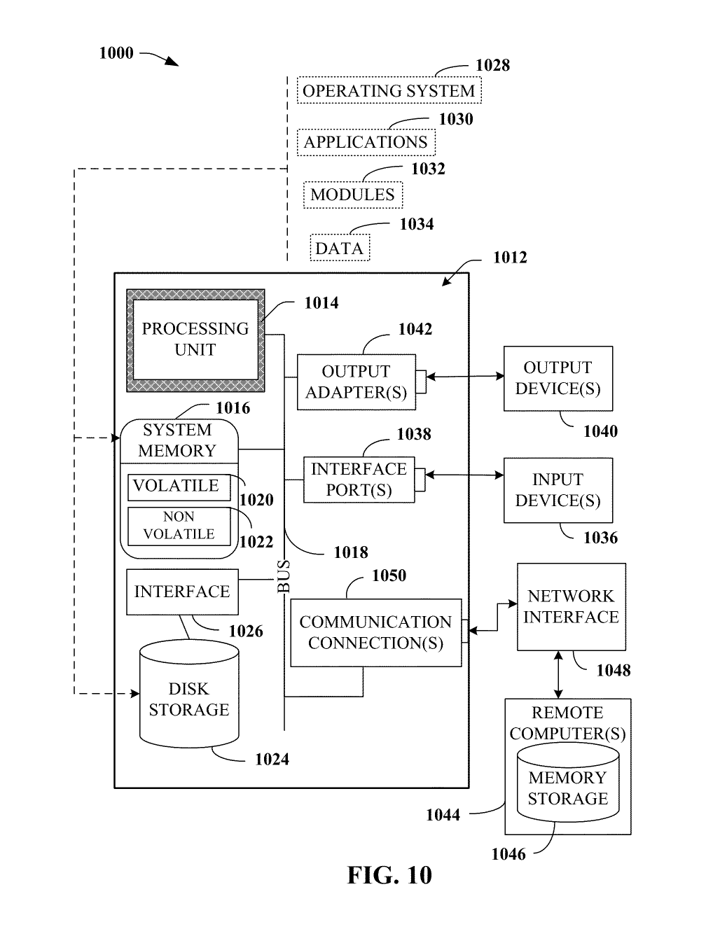

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that perform particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, including single-processor or multiprocessor computer systems, mini-computing devices, mainframe computers, as well as personal computers, hand-held computing devices (e.g., PDA, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of the hardware of a mobile reporting component or UE, e.g., 430, a RAN component, an analysis component, e.g., 110, 210, 310, etc., includes a processing unit 1014, a system memory 1016, and a system bus 1018. System bus 1018 couples system components including, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics, VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1016 can include volatile memory 1020 and nonvolatile memory 1022. A basic input/output system (BIOS), containing routines to transfer information between elements within computer 1012, such as during start-up, can be stored in nonvolatile memory 1022. By way of illustration, and not limitation, nonvolatile memory 1022 can include ROM, PROM, EPROM, EEPROM, or flash memory. Volatile memory 1020 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, mobile reporting component 250 can include a user interface embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus (USB), an infrared port, a Bluetooth port, an IP port, or a logical port associated with a wireless service, etc. Output device(s) 1040 use some of the same type of ports as input device(s) 1036.

Thus, for example, a USB port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit-switching networks like Integrated Services Digital Networks (ISDN) and variations thereon, packet switching networks, and Digital Subscriber Lines (DSL). As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point (AP),” “base station,” “NodeB,” “evolved Node B (eNodeB),” “home Node B (HNB),” “home access point (HAP),” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory that stores computer-executable instructions; and
a processor, communicatively coupled to the memory, that facilitates execution of the computer-executable instructions to at least:
receive timing information related to a timing advance for a wireless communications system;
determine a value related to a distance between a user equipment and a component of the wireless communications system, based on the timing information, to facilitate adaptation of a coverage area of the wireless communication system based on the timing information; and
facilitate access to the value.

2. The system of claim 1, wherein the timing information includes a timing advance value corresponding to a propagation delay of a wireless signal transmitted between the user equipment and a base station of the wireless communications system.

3. The system of claim 1, wherein the adaptation of the coverage area includes adaptation of a data structure representing a set of neighbor relations, wherein the set of neighbor relations identifies a base station.

4. The system of claim 3, wherein the processor further facilitates the execution of the computer-executable instructions to manage the data structure representing the set of neighbor relations.

5. The system of claim 4, wherein the instructions to manage the data structure representing the set of neighbor relations includes an instruction for deletion of an identity of a neighbor base station.

6. The system of claim 4, wherein the instructions to manage the data structure representing the set of neighbor relations includes an instruction for addition of an identity of a neighbor base station.

7. The system of claim 4, wherein the instructions to manage the data structure representing the set of neighbor relations includes an instruction for prioritization of an identity of a neighbor base station of the set of neighbor relations.

8. The system of claim 2, wherein the value is determined based on an analysis of a distribution of a set of timing advance values included in the timing information.

9. The system of claim 1, wherein the value is determined based on an analysis of information, including the timing information, corresponding to an occurrence of an event in the wireless communications system.

10. The system of claim 9, wherein the event is a handover event for a user equipment transitioning from a first base station to a second base station of the wireless communications system.

11. The system of claim 9, wherein the event is a neighbor relation event wherein a neighbor base station is detected.

12. The system of claim 1, wherein the access to the value is facilitated for a wireless network planning component of the wireless communications system such that adaptation of the topology of the wireless network can be based on the value.

13. The system of claim 1, wherein the access to the value is facilitated for a notification component such that an alarm or alert can occur based on the value.

14. A method, comprising:
receiving, by a system including a processor, radio area network information correlated to a timing advance characteristic of a wireless device of a radio area network;
determining, by the system, a value, based on the radio area network information, to facilitate adapting a coverage area of the radio area network, wherein the adaptation of the coverage area includes adaptation of a neighbor relation characteristic; and
facilitating access, by the system, to the value.

15. The method of claim 14, wherein the determining includes determining the value to facilitate adapting the coverage area by adapting the neighbor relation characteristic to prioritize a neighbor base station.

16. The method of claim 14, wherein the determining includes determining the value to facilitate adapting the coverage area by adapting the neighbor relation characteristic to remove a neighbor base station.

17. The method of claim 14, wherein the determining the value includes determining data defining a distribution of the radio area network information.

18. The method of claim 14, wherein the determining the value includes correlating the radio area network information to an event in the radio area network.

19. A device of a base station of a wireless communications network, comprising:
a memory that stores computer-executable instructions; and
a processor, communicatively coupled to the memory, that facilitates execution of the computer-executable instructions to at least:
receive a timing advance value related to a propagation delay between a user equipment and the device of the base station of the wireless communications network;
determine a value, based on the timing advance value, to facilitate adaptation of a coverage area of the wireless communications network including a modification of an entry in a neighbor relation data structure, wherein the entry corresponds to a neighbor base station of the wireless communications network; and
facilitating access to the value to facilitate adaptation of the topology of the wireless communications network.

20. The base station of claim 19, wherein the adaptation of the coverage area includes a prioritization of the entry in the neighbor relation data structure.
